(19) United States
(12) Patent Application Publication
(10) Pub. No.: US 2009/0315303 A1
(43) Pub. Date: Dec. 24, 2009

(54) MECHANICALLY ATTACHED LAMINATED SEAMLESS AIRBAG HINGE SYSTEM

(76) Inventor: Harvey Matthew Ettinger, South Lyon, MI (US)

Correspondence Address: FRASER CLEMENS MARTIN & MILLER LLC, 28366 KENSINGTON LANE, PERRYSBURG, OH, 43551, US

(21) Appl. No.: 12/144,183

(22) Filed: Jun. 23, 2008

(51) Int. Cl. B60R 21/16; B60R 22/00

(52) U.S. Cl. 280/728.2; 701/45

(57) ABSTRACT

A system and method for controlling the deployment force of a vehicle airbag that facilitates airbag deployment, militates against fragmentation of the trim panel and deployment section, and is lightweight and cost effective. The system includes a trim piece, an airbag housing, and a reinforced sheet.

### FIELD OF THE INVENTION

The invention relates to air bags and more particularly to methods for controlling the deployment force of a seamless airbag.

### BACKGROUND OF THE INVENTION

Vehicle manufacturers face many challenges when incorporating airbags into vehicle interiors. Currently, airbags may be employed in several locations in a vehicle including seats, pillars, and instrument panels. In each of these applications, the aesthetic appearance of the airbag installation may be an important factor. Additionally, airbags must be incorporated in a cost effective manner while remaining able to sufficiently control rapid and forceful deployments.

Ideally, an airbag incorporated into the interior of a vehicle should give no outward appearance of its presence. A seamless integration into an interior trim panel is preferred by consumers, who have no desire to see tear seams within a vehicle. Additionally, the materials comprising the trim panel and the deployment section of the trim panel should provide a consistent feel of texture and hardness. To meet this end, tear seams defining portions of a trim panel through which the airbag is deployed are preferably located on the under side of a trim panel, not visible to a consumer.

Reduction of the number of components or the amount of material required by an airbag system are typical ways a manufacturer may reduce costs while maintaining aesthetic integration. Additionally, a system requiring fewer manufacturing steps may provide a cost advantage over other airbag systems. A cost effective airbag system may provide a consumer with greater value by allowing a manufacturer to expend resources elsewhere.

Airbag chutes have traditionally been used to control airbag deployment forces on trim panel sections. Chutes are generally metal and surround an airbag canister and provide a hinging area which deflects and guides the airbag toward a deployment section of the trim panel. While effective, airbag chutes are a heavy and expensive component, which if eliminated from an airbag system would provide a substantial cost savings. Flexible guiding systems may be used to circumvent the necessary use of a chute, but have required extensive reinforcement of trim panels or guiding material designed to tear during airbag deployment.

Deployment sections of trim panels, when not used in conjunction with an airbag chute, have required costly and extensive reinforcement of the trim panel. Reinforcement typically includes bonding a flexible sheet of material, such as woven nylon, to the underside of a trim panel in an area that is greater than the deployment section. Trim panel reinforcement militates against fragmentation of the trim panel and deployment section, while providing a “hinge” for the deployment section of the trim panel. Additionally, trim panel reinforcement militates against a deploying airbag from exiting the trim panel in any area other than the deployment section, defined by tear seams or weakened reinforcement.

A size of the deployment section, in relation to the size of the airbag canister will dictate the trim panel reinforcement necessary. Where a deployment section is of substantially the same size as the airbag canister or smaller, extensive trim panel reinforcement is generally necessary, as well as the presence of airbag guides on all sides of the airbag canister. As disclosed in U.S. Pat. No. 6,079,733, trim panel reinforcement and airbag guiding may be accomplished by the same piece of material when the deployment area encompasses approximately the same area as the airbag canister. Despite being a functional design, a large amount of material is required to guide the airbag, in addition to trim panel reinforcement outside of the deployment area, necessitating additional material and manufacturing cost.

Reinforcement for trim panels and an airbag guiding material must be strong yet flexible, and generally is composed of woven nylon fibers having a polymeric covering. Typically known as “scrim” material, it is commonly incorporated into airbag systems as a reinforcing, guiding, and hinging material. Despite being a rather inexpensive material for reinforcing, guiding, and hinging, “scrim” has a tendency to tear under deployment forces, affording inconsistent performance when used. Alternatives to “scrim”, like steel hinge systems and thermoplastic olefin trim components, have generally been excessive in cost and weight.

It would be desirable to produce a system for controlling the deployment force of an airbag, wherein the system facilitates airbag deployment without trim panel reinforcement. Additionally, a system that militates against fragmentation of the trim panel and deployment section that is lightweight and cost effective would be particularly advantageous.

### SUMMARY OF THE INVENTION

Presently provided by the invention, a system for controlling the deployment force of an airbag that is lightweight and cost effective, wherein the system facilitates airbag deployment without trim panel reinforcement that militates against fragmentation of the trim panel and deployment section has surprisingly been discovered.

In one embodiment, the system for controlling the deployment force of a vehicle airbag comprises a trim piece including a deployment section having a first length, an airbag housing, wherein the housing is rigidly affixed within a vehicle and disposed adjacent the trim piece, the housing having a second length less than the first length, and a reinforced sheet having a width, the width greater than the second length, wherein the reinforced sheet is securely attached to the deployment section and the housing.

In another embodiment, the system for controlling the deployment force of a vehicle airbag comprises a trim piece including a deployment section having a first length, an airbag housing, wherein the housing is rigidly affixed within a vehicle and disposed adjacent the trim piece, the housing having a second length less than the first length, a first reinforced sheet having a first width, the first width greater than the second length, wherein the first reinforced sheet is securely attached to the deployment section and the housing, and a second reinforced sheet having a second width greater than the second length, wherein said second reinforced sheet is secured to said trim piece and said housing.

The invention also provides methods for controlling the deployment force of an airbag.

In one embodiment, the method for controlling the deployment force of a vehicle airbag comprising the steps of providing a trim piece including a deployment section having a first length, providing an airbag housing, the housing having a second length less than the first length and an airbag within, providing a reinforced sheet having a width, the width greater than the second length, attaching the reinforced sheet to the deployment section of the trim piece, disposing the airbag housing adjacent the trim piece, wherein the airbag housing is rigidly affixed within the vehicle, attaching the reinforced sheet to the airbag housing, deploying the airbag, causing the airbag to impact the reinforced sheet, exerting force on the deployment section, separating the deployment section from the trim piece, and restraining the deployment section during airbag deployment, the deployment section restrained by the reinforced sheet, wherein the reinforced sheet is restrained by attachment means to the airbag housing.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a perspective view of a system for controlling the deployment force of a vehicle airbag including a trim piece, an airbag housing, and a reinforced sheet according to an embodiment of the invention.

FIG. 2 is a partially exploded perspective view of the system for controlling the deployment force of a vehicle airbag illustrated in FIG. 1.

FIG. 3 is a cross-sectional side elevational view of the system for controlling the deployment force of a vehicle airbag illustrated in FIG. 1.

FIG. 4 is a cross-sectional side elevational view of the system for controlling the deployment force of a vehicle airbag illustrated in FIG. 1, showing the airbag deployed.

FIG. 5 is a perspective view of a system for controlling the deployment force of a vehicle airbag including a trim piece, an airbag housing, and a reinforced sheet according to another embodiment of the invention.

FIG. 6 is a partially exploded perspective view of the system for controlling the deployment force of a vehicle airbag illustrated in FIG. 5.

### DETAILED DESCRIPTION OF EXEMPLARY EMBODIMENTS OF THE INVENTION

The following detailed description and appended drawings describe and illustrate an exemplary embodiment of the present invention. The description and drawings serve to enable one skilled in the art to make and use the invention, and are not intended to limit the scope of the invention in any manner. It is understood that materials other than those described can be used without departing from the scope and spirit of the invention. In respect of the methods disclosed, the steps presented are exemplary in nature, and thus, the order of the steps is not necessary or critical.

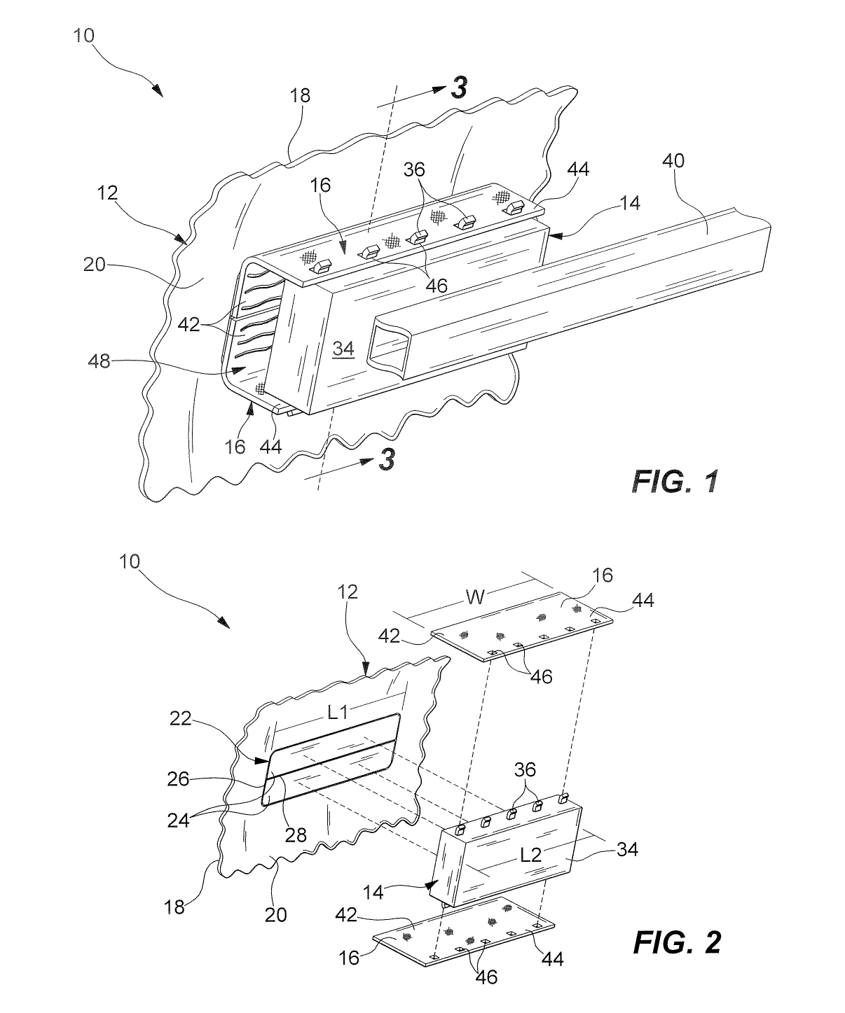

FIG. 1 shows a system 10 for controlling the deployment force of a vehicle airbag according to an embodiment of the invention. The system 10 includes a trim piece 12, an airbag housing 14, and a reinforced sheet 16.

The trim piece 12 can be produced from any conventional material used to manufacture vehicle interior panels such as vinyl and plastic, for example. As shown, the trim piece 12 is an instrument panel, but other panels such as vehicle doors, pillars, center consoles, and ceilings may be used. Additionally, the trim piece 12 can be manufactured through any conventional process such as injection molding. The trim piece 12 has an outer surface 18 facing towards an interior of the vehicle, and an inner surface 20. The outer surface 18 may be textured or formed of a material that has an aesthetic appeal to vehicle occupants. The inner surface 20 includes a tear pattern 22 defining a deployment section 24 of the trim piece 12. The inner surface 20 may also include a fastening means (not shown) such as attachment points or a rigid structure for attaching the trim piece 12 to the vehicle.

The tear pattern 22 may include a groove 26 as illustrated in FIG. 2 or other patterns such as a plurality of apertures. The tear pattern 22 may be formed during production of the trim piece 12 or during a secondary operation such as laser scoring. As shown, the groove 26 defines two substantially rectangular deployment sections 24, although other shapes of the groove 26 and the deployment sections 24 may be used as desired. The deployment sections 24 have a first length L1 substantially parallel to a width W of the reinforced sheet 16 and greater in magnitude than a second length L2 of the airbag housing 14. The deployment sections 24 share a peripheral edge 28, and it is to be noted where a tear pattern 22 defines more than one deployment section 24 a peripheral edge 28 will be shared.

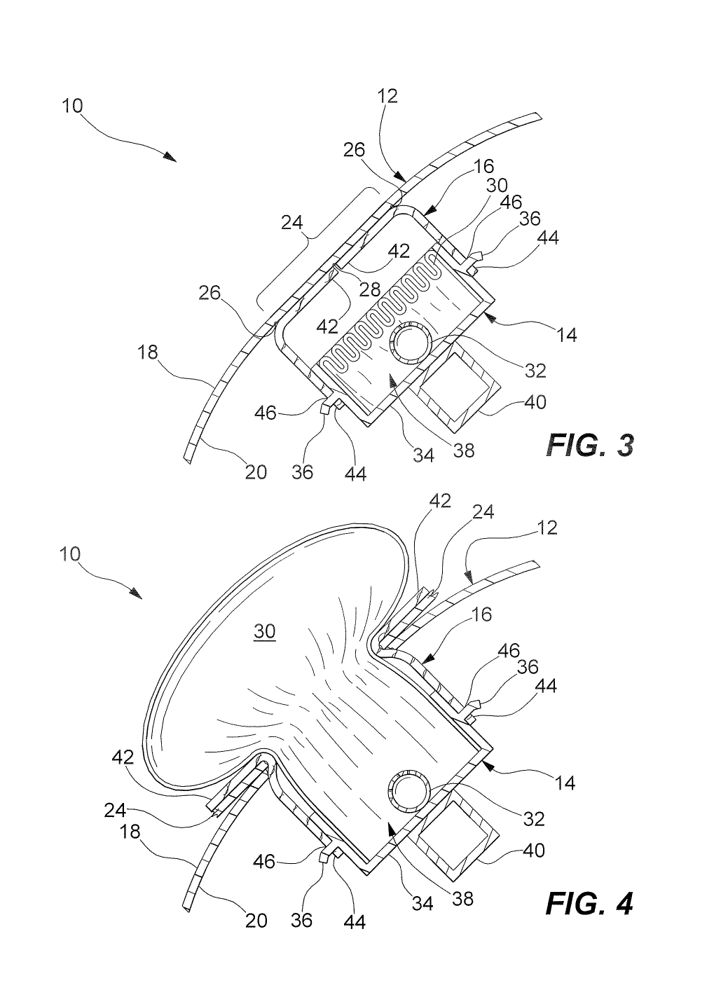

As illustrated in FIG. 3 and 4, the airbag housing 14 receives an airbag 30 and deployment mechanism 32. The airbag housing 14 includes an exterior 34 having a plurality of retainers 36 formed thereon and a cavity 38 containing one of an airbag 30 and an airbag canister. The airbag housing 14 can be produced from any conventional material such as plastic, for example. Furthermore, the airbag housing 14 may be produced by injection molding. The retainers 36 may be integrally formed on the exterior 34, or produced separately and fastened to the exterior 34. As shown, the retainers 36 may be hooks or a similar device for fastening the reinforced sheet 16 to the airbag housing 14. The airbag housing 14 may be an airbag canister as depicted, having the airbag 30 and deployment mechanism 32 directly disposed in the cavity 38. Additionally, an airbag canister may be separate from the airbag housing 14 and disposed and securely attached to the airbag housing 14 within the cavity 38. The airbag housing 14 may be affixed by any conventional means to a cross car beam 40.

Shown in FIG. 2, the airbag housing 14 has a second length L2, substantially parallel to the width W of the reinforced sheet 16 and smaller in magnitude than a first length L1. Additionally, the second length L2 is smaller in magnitude than the width W of the reinforced sheet 16.

The reinforced sheet 16 may be formed from any conventional material such as a plurality of laminated sheets of a strong and flexible material such as a woven polypropylene fiber. The reinforced sheet 16 may have a rectangular shape, having the width W, and two ends substantially perpendicular to the side having the width W. A first end 42 is securely attached to the deployment section 24. Any conventional method such as sonic welding, integral molding, or an adhesive may be used to securely attach the first end 42 to the deployment section 24. A second end 44 is fastened to the airbag housing 14. As shown in FIGS. 1 through 4, retainers 36 on the airbag housing 14 correspond to apertures 46 in the reinforced sheet, affording secure attachment between the reinforced sheet 16 and the airbag housing 14. Other fastening methods, such as J-channel clips may be suitably employed if desired.

FIGS. 3 and 4 show the system 10 in a stored position and a deployed position for the airbag 30. In use, the system 10 controls the deployment force of a vehicle airbag 30. The deployment device 32 is activated by an electrical signal, the signal typically resulting from a severe vehicle deceleration detected by a sensor as is known in the art. Upon activation, the deployment device rapidly creates a gas, filling the airbag 30. The partially filled airbag 30 fills the area enclosed by the reinforced sheets 16 and airbag housing 14 and exerts a force on the reinforced sheets 16. The reinforced sheets 16 and the deployment sections 24 militate against escape of the expanding airbag 30 from an unenclosed area 48 shown in FIG. 1 at either end of the reinforced sheets 16. Particularly, the expanding airbag 30 is retained by the greater magnitude of the width W and the length L1 as compared to the length L2. The rapidly expanding airbag 30, guided by the reinforced sheets 16 exerts significantly more force on the shared peripheral edge 28 than a force used to laterally expand the airbag towards the unenclosed area 48. The resulting force causes the trim panel 12 to elastically deform, tearing the trim panel 12 along the groove 26 in a substantially “H” shaped pattern and separating the reinforced sheets 16 along the peripheral edge 28. The airbag 30 expands through the trim panel 12, into an occupant compartment of the vehicle.

The deployment sections 24 of the trim panel 12 are restrained from becoming projectiles under the force of the deploying airbag 30 by the reinforced sheets 16 to which they are bonded. The reinforced sheets 16 act as a “hinge” for the deployment sections 24, pivoting them towards the outer surface 20 of the trim panel 12. Portions of the trim panel 12 that are not deployment sections 24 do not fragment because the deployment sections 24 and reinforced sheets 16 have the length L1 and the width W greater in magnitude than the length L2 of the airbag housing 14. Accordingly, reinforcement of the trim panel 12 is not required in an area larger than the deployment sections 24, resulting in a lightweight and cost effective solution to controlling the deployment force of an airbag 30.

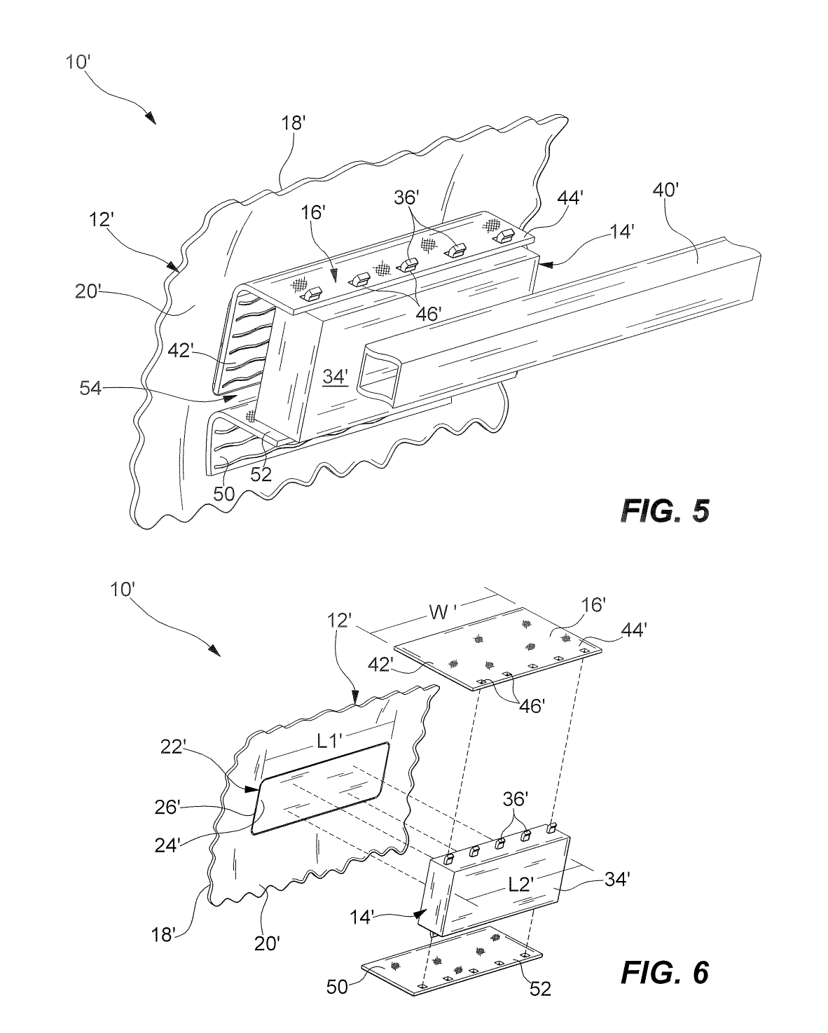

FIGS. 5 and 6 shows a system 10′ for controlling the deployment force of a vehicle airbag according to another embodiment of the present invention similar to the system 10 of FIGS. 1 thru 4, except as described below. Structure repeated from the description of FIGS. 1 thru 4 includes the same reference numeral and a prime (′) symbol. As shown in FIG. 6, the groove 26′ defines a single substantially rectangular deployment section 24′. A reinforced sheet 16′ is secured to the deployment section 24′ by any conventional means such as sonic welding, integral molding, or an adhesive. FIG. 5 shows a second reinforced sheet 50 secured to the trim panel 12′ by any conventional means such as sonic welding, integral molding, or an adhesive. A second sheet end 52 is fastened to the airbag housing 14′ similar to the second end 44′. In use, the reinforced sheet 16′ acts as a “hinge” for the deployment section 24′, pivoting the deployment section 24′ towards the outer surface 20′ of the trim panel 12′. The second reinforced sheet 50 acts solely as a guide for the deploying airbag, directing force towards the trim panel 12′ and deployment section 24′. The resulting force causes the trim panel 12′ to elastically deform, tearing the trim panel 12′ along the groove 26′ in a substantially “U” shaped pattern and separating the reinforced sheet 16′ from the trim panel 12′ along a sheet junction 54.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

1. A system for controlling the deployment force of a vehicle airbag comprising:
a trim piece including a deployment section having a first length;
an airbag housing, wherein said housing is affixed within a vehicle and disposed adjacent said trim piece, said housing having a second length less than the first length; and
a first reinforced sheet having a width greater than the second length, wherein said reinforced sheet is secured to the deployment section and said housing forming an unenclosed area between said trim piece and said housing.

2. A system for controlling the deployment force of a vehicle airbag according to claim 1, wherein said first reinforced sheet is produced from woven polypropylene.

3. A system for controlling the deployment force of a vehicle airbag according to claim 1, wherein said first reinforced sheet is secured to the deployment section by sonic welding.

4. A system for controlling the deployment force of a vehicle airbag according to claim 1, wherein said first reinforced sheet has a plurality of apertures formed therein.

5. A system for controlling the deployment force of a vehicle airbag according to claim 4, wherein said airbag housing has a plurality of retainers adapted to be received in the apertures of said first reinforced sheet.

6. A system for controlling the deployment force of a vehicle airbag according to claim 1, wherein said airbag housing has a means for retaining said first reinforced sheet disposed thereon.

7. A system for controlling the deployment force of a vehicle airbag according to claim 1, further comprising a second reinforced sheet secured to the deployment section and the housing.

8. A system for controlling the deployment force of a vehicle airbag according to claim 1, wherein said trim piece includes two deployment sections sharing a peripheral edge.

9. A system for controlling the deployment force of a vehicle airbag according to claim 1, wherein said airbag housing is rigidly affixed to a cross car beam.

10. A system for controlling the deployment force of a vehicle airbag comprising:
a trim piece including a deployment section having a first length;
an airbag housing, wherein said housing is affixed within a vehicle and disposed adjacent said trim piece, said housing having a second length less than the first length;
a first reinforced sheet having a first width greater than the second length, wherein said first reinforced sheet is secured to the deployment section and said housing; and
a second reinforced sheet having a second width greater than the second length, wherein said second reinforced sheet is secured to said trim piece and said housing, said first reinforced sheet and said second reinforced sheet formin an unenclosed area between said trim ieee and said housing.

11. A system for controlling the deployment force of a vehicle airbag according to claim 10, wherein said first and said second reinforced sheets are produced from woven polypropylene.

12. A system for controlling the deployment force of a vehicle airbag according to claim 10, wherein said first and said second reinforced sheets are secured to the deployment section and said trim piece by sonic welding.

13. A system for controlling the deployment force of a vehicle airbag according to claim 10, wherein said first and said second reinforced sheets have a plurality of apertures formed therein.

14. A system for controlling the deployment force of a vehicle airbag according to claim 13, wherein said airbag housing has a plurality of retainers adapted to be received in the apertures of said first and said second reinforced sheets.

15. A system for controlling the deployment force of a vehicle airbag according to claim 10, wherein said airbag housing has a means for retaining said first and said second reinforced sheets disposed thereon.

16. A system for controlling the deployment force of a vehicle airbag according to claim 10, wherein said airbag housing is rigidly affixed to a cross car beam.

17. A method for controlling the deployment force of a vehicle airbag comprising the steps of:
providing a trim piece including a deployment section having a first length;
providing an airbag housing, the housing having a second length less than the first length and an airbag within;
providing a reinforced sheet having a width greater than the second length;
attaching the reinforced sheet to the deployment section of the trim piece;
disposing the airbag housing adjacent the trim piece, wherein the airbag housing is affixed within the vehicle; and
attaching the reinforced sheet to the airbag housing to form an unenclosed area between the trim piece and the airbag housing, wherein upon deployment of the airbag, the airbag is caused to impact the reinforced sheet, exerting force on the deployment section and separating the deployment section from the trim piece, the deployment section restrained during airbag deployment by the reinforced sheet, wherein the reinforced sheet is restrained by attachment means to the airbag housing.

18. The method for controlling the deployment force of a vehicle airbag according to claim 17, wherein the reinforced sheet is produced from woven polypropylene.

19. The method for controlling the deployment force of a vehicle airbag according to claim 17, wherein said first reinforced sheet is secured to the deployment section by sonic welding.

20. The method for controlling the deployment force of a vehicle airbag according to claim 17, wherein the airbag housing has a plurality of retainers adapted to be received in a plurality of apertures in the reinforced sheet.
